(19) United States
(12) Patent Application Publication
(10) Pub. No.: US 2025/0111264 A1
(43) Pub. Date: Apr. 3, 2025

(54) COMBINING MODEL OUTPUTS

(71) Applicant: INTERNATIONAL BUSINESS MACHINES CORPORATION, Armonk, NY (US)

(72) Inventors: Matthew Richard Arnold, Carmel, NY (US); Benjamin Tyler Elder, Hawthorne, NY (US); Zhongzheng Shu, Malden, MA (US); Mohammadreza Fazeli, Toronto (CA)

(21) Appl. No.: 18/476,442

(22) Filed: Sep. 28, 2023

(51) Int. Cl. G06N 20/00; G06N 3/006

(52) U.S. Cl. CPC G06N 20/00; G06N 3/006

(57) ABSTRACT

A method, a structure, and a computer system for combining model outputs. The exemplary embodiments may include receiving two or more outputs from two or more models, combining the two or more outputs, and generating a final output based on the combining.

### BACKGROUND

The exemplary embodiments relate generally to machine learning models, and more particularly to combining machine learning model outputs.

Manually labelling data is one of the largest sources of frustration when training machine learning algorithms, for example when authoring components of a Virtual Assistant (VA). It is therefore appealing for the algorithm to learn automatically, for example through reinforcement learning (RL) techniques and unsupervised learning techniques, rather than relying solely on supervised learning techniques. These automatic learning techniques, however, do not completely replace supervised learning techniques. Typically, supervised learning models are used to bootstrap an algorithm when it first goes live and, having more controllable behaviour, they remain available for the algorithm authors to continue crafting the training. Although it is desirable to incorporate all of the benefits of unsupervised, supervised, and reinforcement learning when training machine learning algorithms, it creates the challenge of making predictions based on multiple models that may be minimally or partially trained, have different architectures, and are trained using different data.

### SUMMARY

The exemplary embodiments disclose a method, a computer program product, and a computer system for combining model outputs. The exemplary embodiments may include receiving two or more outputs from two or more models, combining the two or more outputs, and generating a final output based on the combining.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary block diagram depicting the components of computing environment 100, in accordance with the exemplary embodiments.

FIG. 2 depicts an exemplary flowchart 200 illustrating operations of combining program 150 of computing environment 100, in accordance with the exemplary embodiments.

FIG. 3 depicts a functional flowchart 300 illustrating the operations of combining program 150, in accordance with the exemplary embodiments.

FIG. 4 depicts a functional flowchart 400 illustrating the operations of combining program 150 implementing a pairwise max function, in accordance with the exemplary embodiments.

FIG. 5 depicts a functional flowchart 500 illustrating the operations of combining program 150 with calibration and dynamic weighted average, in accordance with the exemplary embodiments.

FIG. 6 depicts a functional flowchart 600 illustrating the operations of combining program 150 with customizable rules, in accordance with the exemplary embodiments.

FIG. 7 depicts a functional flowchart 700 illustrating the operations of combining program 150 with dynamic adapting and throttling, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

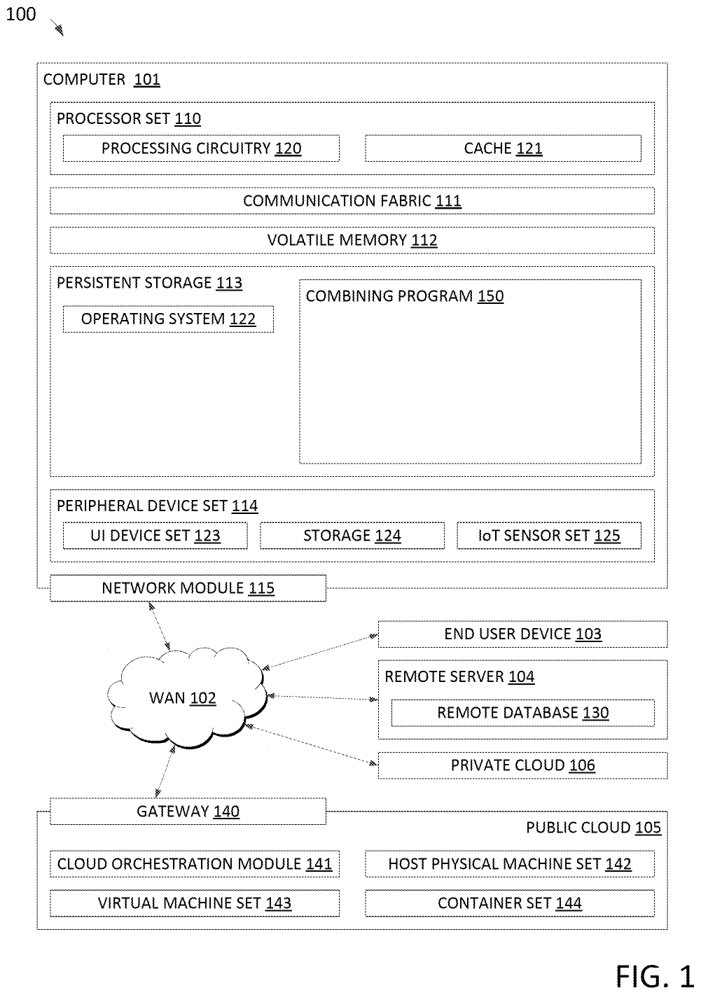

FIG. 1 depicts an exemplary block diagram depicting the components of computing environment 100, in accordance with the exemplary embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as combining program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user, and may take any of the forms discussed above with respect to computer 101. The EUD 103 may further include any components described with respect to computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

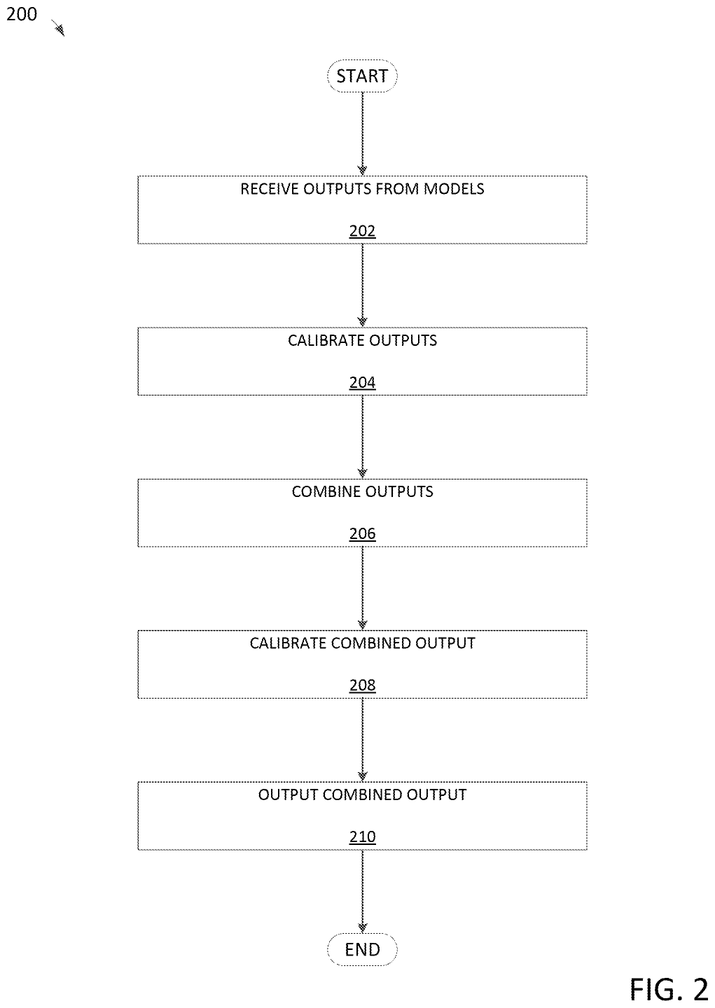

FIG. 2 depicts an exemplary flowchart 200 illustrating the operations of combining program 150 of computing environment 100, in accordance with the exemplary embodiments.

As previously noted, manually labelling data is one of the largest sources of frustration when training machine learning algorithms, for example when authoring components of a Virtual Assistant (VA). It is therefore appealing for the algorithm to learn automatically, for example through reinforcement learning (RL) techniques and unsupervised learning techniques, rather than relying solely on supervised learning techniques. These automatic learning techniques, however, do not completely replace supervised learning techniques. Typically, supervised learning models are used to bootstrap an algorithm when it first goes live and, having more controllable behaviour, they remain available for the algorithm authors to continue crafting the training. Although it is desirable to incorporate all of the benefits of unsupervised, supervised, and reinforcement learning when training machine learning algorithms, it creates the challenge of making predictions based on multiple models that may be minimally or partially trained, have different architectures, and are trained using different data.

Despite the large body of work in combining machine learning techniques, there are currently no methods for combining methods such as SL and RL models in a way that solves the existing problems in the current state of the art.

For example, in Warm Starting Contextual Bandits, you must first declare which of your models is the ground truth in the case that they differ. However, different aspects of each model are trusted in different situations, and therefore neither can be selected as a ground truth. This approach also assumes that the SL model is used only to get things started, at which point RL takes over. Here, by contrast, both the SL model and RL model can be used at any time (dual learning).

Moreover, traditional assembling, such as mean, weighted mean, voting, and majority, are non-optimal for combining SL models and RL models. This is because traditional ensemble approaches may utilize weights in an inefficient manner. For example, it is not desirable to lower the confidence of one model when another is unsure. Moreover, when both models have moderate uncertainty, we want to leverage both.

Even fine-grained combining of data (mix all the data together) suffers from the problems with the current state of the art. For example, fine-grained combining requires retraining all the (combined) data when either model changes. Moreover, it requires using the same model architecture and implementation for both sources of data. This makes explaining the output more difficult and makes it harder to adjust the influence of each model independently.

The present invention was conceived to address the deficiencies in the current state of the art by providing an efficient and effective means for combining different learning models. In addressing such deficiencies through the novel combination of learning model outputs, the present invention improves upon the functioning of a computing device and the field of machine learning. During this process, the different learning models are separately trained and predict separate outputs prior to combining the separate outputs into a single, final output using a combining function. This approach has shown to excel in situations where the one or more models may be minimally/partially trained and additionally does not allow for a low confidence output to bring down a higher confidence output within the final output. Embodiments of this approach may further improve upon the current state of the art through application of independent calibrations to the initial outputs and the final output. Still further embodiments of the present invention may improve upon the current state of the art through use of a custom combiner with rules, a custom combiner with uncertainty, and a custom combiner with dynamic adapting and throttling.

A detailed description of the present invention is now provided with respect to FIG. 2-7.

Combining program 150 may receive outputs from models (step 202). In embodiments, combining program 150 may receive two or more outputs from two or more machine learning models that are configured to produce a like output (e.g., a prediction). The models may be components of a program, for example a program configured to perform tasks such as provide virtual assistance, detect fraudulent purchases, direct robots, etc., and the models may produce the output by performing a function on an input. The models may, for example, be supervised learning models, reinforcement learning models, unsupervised learning models, rule-based models, etc. In embodiments, the received model outputs may be in the form of a vector having vector components at positions within vector columns and rows.

In embodiments, combining program 150 may receive outputs from various types of models. For example, combining program 150 may receive outputs from supervised learning (SL) models which are trained to build a function that maps labelled input/output pairs. Once trained, the models may be applied to new data to predict an output based on the function. The trained models may implement algorithms such as support-vector machines, linear regression, logistic regression, naïve Bayes, linear discriminant analysis, decision trees, K-nearest neighbour algorithm, neural networks, similarity testing, etc., all while considering factors such as bias-variance trade-off, function complexity and amount of training data, dimensionality of the input space, and noise in the output values.

Combining program 150 may additionally receive outputs from unsupervised and reinforcement learning models. For example, combining program 150 may receive outputs from unsupervised clustering models and reinforcement learning (RL) models that learn to maximize an expected cumulative reward through positive and negative reinforcement. The unsupervised models may implement approaches such as neural networks while the RL models may implement approaches such as a Markov decision process, criterion of optimality, brute force, value function, Monte Carlo methods, temporal difference methods, function approximation methods, direct policy search, model-based algorithms, etc.

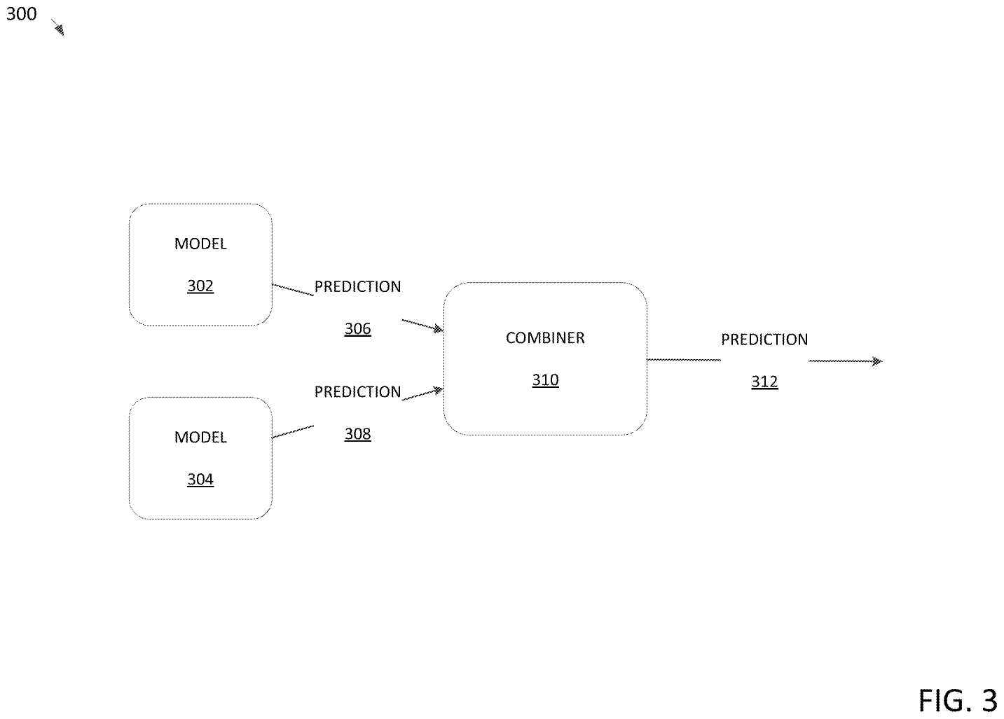

Reference is now made to FIG. 3 which depicts an example operation of combining program 150. Here, combining program 150 receives outputs from models that are components of a virtual assistant program configured to interact with a user (i.e., a chatbot). The models include SL model 302 and RL model 304 that are configured to output user intent predictions 306 and 308, respectively. The outputs may be in vector form where each position within the vector corresponds to a different intent and the corresponding values represents a confidence that a user statement matches that intent. The SL model may be pretrained to associate user inputs with intents while the RL model may be trained based on the performance of the virtual assistant via user feedback (for example, explicit signals such as a thumbs up/thumbs down and implicit signals such as clarifying questions, tone analysis, etc.).

As noted above, the outputs received by combining program 150 may be from different model architectures and therefore, when strategically combined below, incorporate the different strengths and weaknesses of the various models. Not only does the combining of different model outputs increase an applicability and accuracy of the underlying program, but it further allows for the models to be trained simultaneously, maximizing time and data efficiency. Moreover, by selectively combining only the most accurate components of the multiple outputs, the models producing the outputs may be in various or even initial stages of training. In fact, the present invention is shown to excel at combining the outputs of minimally/partially trained models, and these advantages may further allow for increased training speed, decreased training time, decreased training resource consumption, and increased performance of a program implementing combining program 150. This functionality additionally allows for rapid deployment and continual updating of such programs.

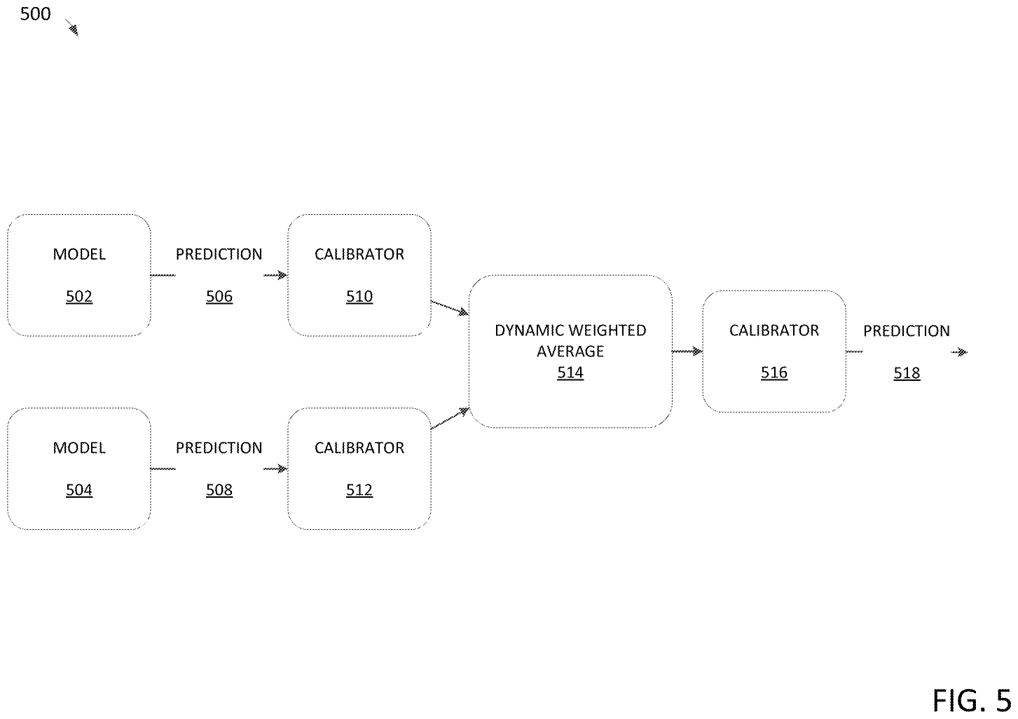

Returning to the FIG. 2 flowchart, combining program 150 may perform a calibration of the received model outputs (step 204). Because the models may have different architectures and can be trained using different sets of training data, combining program 150 may independently calibrate the outputs to improve results of the combining. As illustrated by FIG. 5, the calibration may be performed on the independent outputs of each model as well as on a final output. While the calibration process may depend largely on model architecture, design, and training data, example calibrations may include calibrating both models to reproduce predictions on a held out test set, calibrating the output features of one model to reproduce output features of another model, etc.

Combining program 150 may combine the outputs (step 206). Combining program 150 may combine the outputs using various techniques that weight or unweight components of the outputs. Of the multiple outputs received and through the combining process, combining program 150 may ultimately select an output, components of an output, or a combination of output components for use in generating a final output. The combining techniques may be preset, selected by a user, or determined dynamically, for example through use of machine learning. In embodiments where combining techniques are dynamically selected, combining program 150 may, for example, develop an algorithm to identify the best performing combining techniques based on features of an input and corresponding performance.

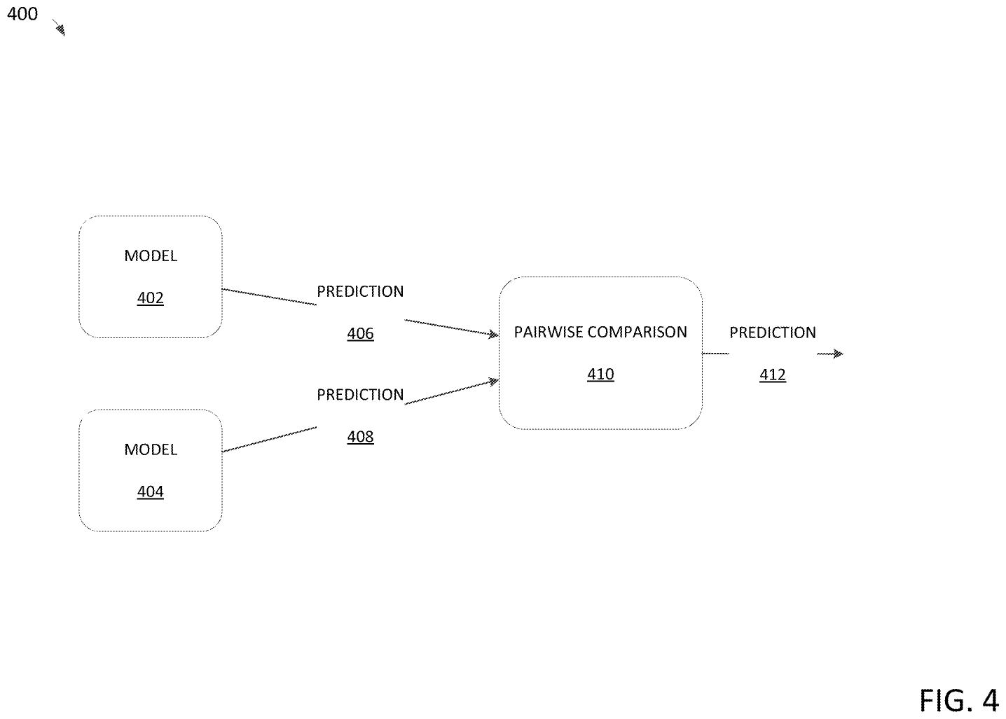

As noted above, combining program 150 may implement various combining techniques when combining the outputs. In embodiments, and depicted by FIG. 4, combining program 150 may perform a pairwise comparison in which combining program 150 compares the components of the model outputs to each other in pairs. For example, if the outputs are in vector form, combining program 150 may compare the values in a position of one vector with those in a same position of the other vector. Based on the comparison, combining program 150 may select an output value using criteria such as a pairwise weighted average, a maximum, a minimum, a mean, a median, etc. In an illustrative embodiment depicted by FIG. 4, combining program 150 may implement a pairwise max function (i.e., 100% weight) such that the maximum of the pairs is selected. This approach prevents lower scoring outputs (e.g., when a model is unsure) from reducing the score of a higher scoring output and is particularly advantageous for models that are minimally trained or excel under different circumstances because only the highest scoring components are selected.

Other variants of pairwise max may be implemented. For example, combining program 150 may implement a pairwise dynamic weighted average where the weight is determined based on a rank from each model. In such embodiments, combining program 150 may maximize a weight of a highest ranked confidence prediction while unweighting all other predictions. In a biased version of pairwise max, combining program 150 may be configured to boost an output of one model by a rule or factor, e.g., multiplied by a factor. In other embodiments, combining program 150 may implement a pairwise dynamic weighted average where the weight is determined based on the confidence from each model. In such embodiments, combining program 150 may implement a confidence biased approach where a weight is equal to a confidence. In a piece-wise constant calibration, if a confidence exceeds a threshold, it may be set to a specific weight while those failing to exceed the threshold are set to another specific weight. While only some variants of pairwise comparison techniques are described herein, combining program 150 may implement various forms of pairwise comparison when combining the outputs of the models.

In the virtual assistant example referenced above and illustrated by FIG. 3, if combining program 150 is configured to implement a pairwise max function on the outputs model_1_prediction=(0.2, 0.3, 0.6) and model_2_prediction=(0.9, 0.1, 0.2), then combining program 150 returns pairwise_max(model_1, model_2)=(0.9, 0.3, 0.6).

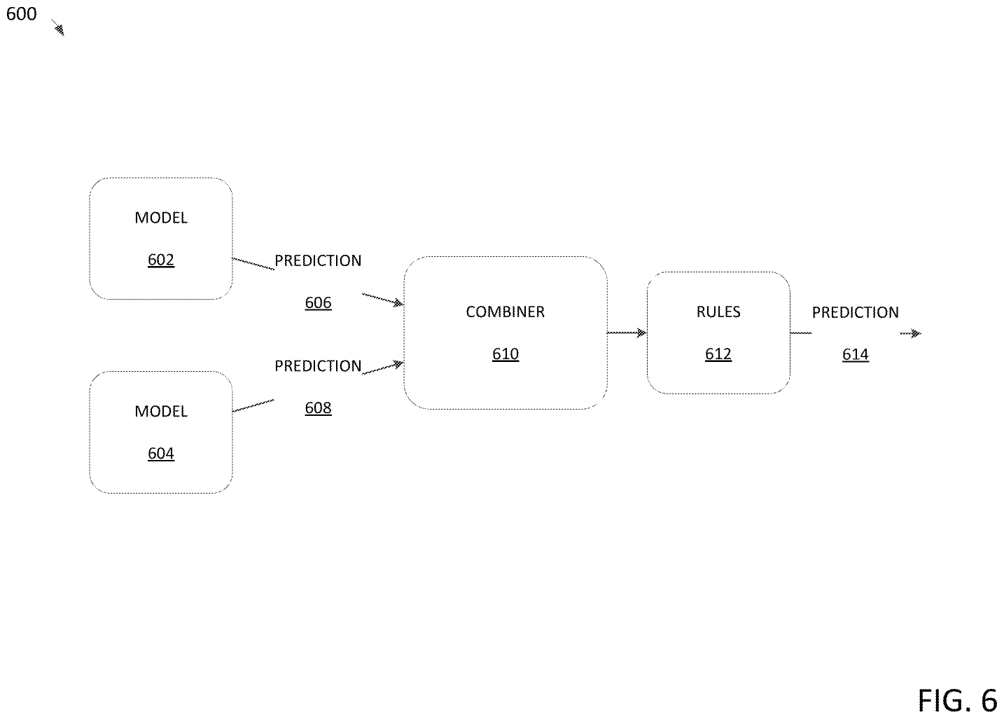

In embodiments, combining program 150 may combine the outputs of the models using other techniques. For example, and with reference to FIG. 6, combining program 150 may combine model outputs based on customizable rules. The rules, which may be preconfigured or set by a user, may be configured to select or combine outputs based on conditions. For example, combining program 150 may apply a rule to select an output having a score exceeding a threshold and, if no score exceeds the threshold, to average the scores. It will be appreciated that combining program 150 may be configured to implement various rules depending on application.

Alternatively, combining program 150 may select a model output based on leveraging uncertainty. Combining program 150 may determine an uncertainty using techniques such as a bootstrap, dropout, etc., and a custom combiner can use approaches such as leveraging the lower confidence bound when combining. For example, combining program 150 may prevent one model from influencing a final prediction unless the model is confident above an elevated threshold. Here, if one output is a single value, e.g., x=0.7, and another that is a value with uncertainty, e.g., y=0.5+/−0.1, then a rule may dictate selecting the single number only if it falls inside the uncertainty band and otherwise selecting a value on the edge of the band closest to this number, i.e., 0.6 (0.5+0.1=closest edge of uncertainty band to the single point).

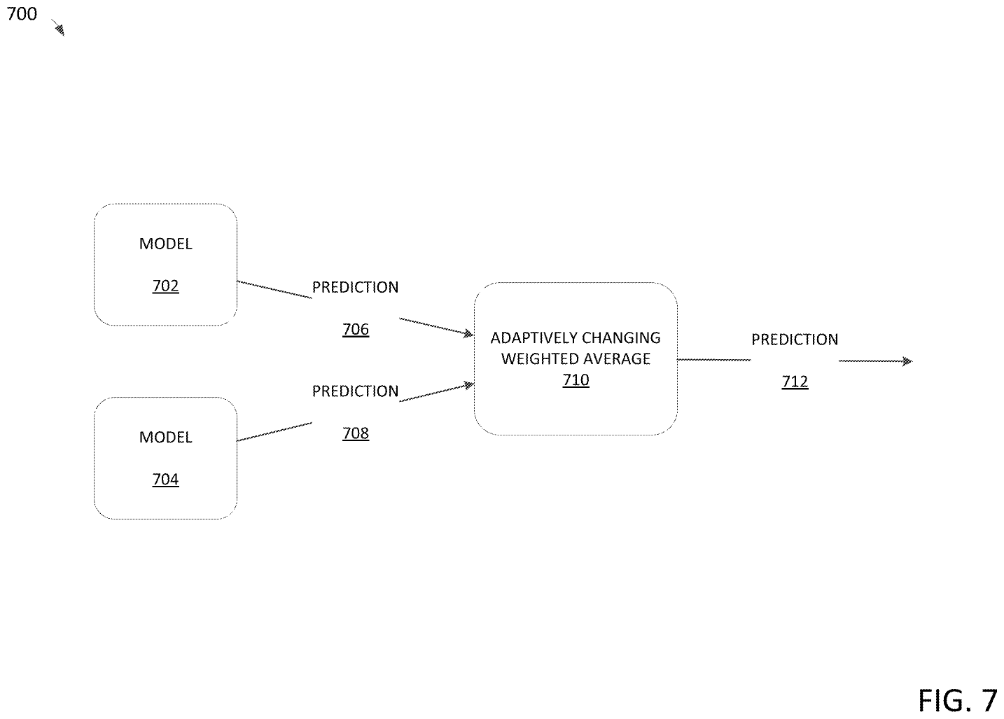

Moreover, combining program 150 may select outputs based on dynamic adapting and throttling. As illustrated by FIG. 7, combining program 150 may be configured to modify the combiner to change the influence of either model based on performance at the time. In this approach, combining program 150 may increase an influence of a better performing model while decreasing an influence of lesser performing models, e.g., through weighting. Combining program 150 may further throttle (i.e., limit) a number of changes of a certain type that a model is allowed to make, e.g., using a budget or time window, at which point it is throttled or its influence is reduced. For example, dynamic adapting and throttling may include rules such as if a condition is met, then increase a weight of a model in weighted average, or if another condition is met, then increase parameter to skew distribution to more heavily favour the top choice of one model. While several combining approaches are described above for illustrative purposes, it will be appreciated that various combining approaches may be implemented to maximize performance.

Combining program 150 may calibrate an output of the combining (step 208). In embodiments, combining program 150 may calibrate the combined output by, for example, calibrating the combined output to match aspects of a pre-determined distribution.

Combining program 150 may generate a final output based on the combining (step 210). The final output may be used by the underlying program for which the models are configured. For example, the final output may identify an intent of a user interacting with a chatbot, identify fraudulent activity, direct robots, etc.

FIG. 3 depicts a functional flowchart 300 illustrating the operations of combining program 150, in accordance with the exemplary embodiments.

FIG. 4 depicts a functional flowchart 400 illustrating the operations of combining program 150 implementing a pairwise max function, in accordance with the exemplary embodiments.

FIG. 5 depicts a functional flowchart 500 illustrating the operations of combining program 150 with calibration and dynamic weighted average, in accordance with the exemplary embodiments.

FIG. 6 depicts a functional flowchart 600 illustrating the operations of combining program 150 with customizable rules, in accordance with the exemplary embodiments.

FIG. 7 depicts a functional flowchart 700 illustrating the operations of combining program 150 with dynamic adapting and throttling, in accordance with the exemplary embodiments.

1. A method for combining model outputs, the method comprising:
receiving two or more outputs from two or more models;
combining the two or more outputs; and
generating a final output based on the combining.

2. The method of claim 1, further comprising:
calibrating at least one of the final output and the two or more outputs.

3. The method of claim 1, wherein:
the two or more models include a reinforcement learning model and a supervised learning model.

4. The method of claim 1, wherein the two or more models identify an intent of a user within a virtual assistant program.

5. The method of claim 1, wherein the combining further comprises:
applying a pairwise weighted average to the two or more outputs.

6. The method of claim 5, wherein the pairwise weighted average is 100% of one of the two or more outputs.

7. The method of claim 1, wherein the combining further comprises:
applying customizable rules to the two or more outputs.

8. A computer program product for combining model outputs, the computer program product comprising:
one or more non-transitory computer-readable storage media and program instructions stored on the one or more non-transitory computer-readable storage media capable of performing a method, the method comprising:
receiving two or more outputs from two or more models;
combining the two or more outputs; and
generating a final output based on the combining.

9. The computer program product of claim 8, further comprising:
calibrating at least one of the final output and the two or more outputs.

10. The computer program product of claim 8, wherein:
the two or more models include a reinforcement learning model and a supervised learning model.

11. The computer program product of claim 8, wherein the two or more models identify an intent of a user within a virtual assistant program.

12. The computer program product of claim 8, wherein the combining further comprises:
applying a pairwise weighted average to the two or more outputs.

13. The computer program product of claim 12, wherein the pairwise weighted average is 100% of one of the two or more outputs.

14. The computer program product of claim 8, wherein the combining further comprises:
applying customizable rules to the two or more outputs.

15. A computer system for combining model outputs, the system comprising:
one or more computer processors, one or more computer-readable storage media, and program instructions stored on the one or more of the computer-readable storage media for execution by at least one of the one or more processors capable of performing a method, the method comprising:
receiving two or more outputs from two or more models;
combining the two or more outputs; and
generating a final output based on the combining.

16. The computer system of claim 15, further comprising:
calibrating at least one of the final output and the two or more outputs.

17. The computer system of claim 15, wherein:
the two or more models include a reinforcement learning model and a supervised learning model.

18. The computer system of claim 15, wherein the two or more models identify an intent of a user within a virtual assistant program.

19. The computer system of claim 15, wherein the combining further comprises:
applying a pairwise weighted average to the two or more outputs.

20. The computer system of claim 19, wherein the pairwise weighted average is 100% of one of the two or more outputs.
